(19) United States
(12) Patent Application Publication
(10) Pub. No.: US 2018/0307816 A1
(43) Pub. Date: Oct. 25, 2018

(54) FINGERPRINT IDENTIFICATION MODULE

(71) Applicant: Primax Electronics Ltd., Taipei (TW)

(72) Inventor: Tsung-Yi LU, Taipei (TW)

(21) Appl. No.: 15/705,990

(22) Filed: Sep. 15, 2017

(30) Foreign Application Priority Data
Apr. 21, 2017 (TW) 106113492

(51) Int. Cl. G06F 21/32; G06K 9/00

(52) U.S. Cl. CPC G06F 21/32; G06F 3/165; G06K 9/00013

(57) ABSTRACT

A fingerprint identification module includes a sensing surface, a circuit board, a control unit, a fingerprint sensor and a position sensor. The fingerprint sensor is arranged between the sensing surface and the circuit board. When a finger is placed on the sensing surface, a fingerprint image of the finger is sensed by the fingerprint sensor. The position sensor is arranged between the sensing surface and the circuit board, and electrically connected with the control unit. The position sensor senses a touch pressure on the sensing surface. The control unit acquires a position of the finger on the sensing surface according to the at least one touch pressure.

### FIELD OF THE INVENTION

The present invention relates to an identity identification element, and more particularly to a fingerprint identification module for identifying the identity of a user through a fingerprint.

### BACKGROUND OF THE INVENTION

Recently, a fingerprint identification technology has been widely applied to a variety of electronic device. FIG. 1 is a schematic front view illustrating an electronic device with a fingerprint identification module according to prior art. FIG. 2 is a schematic side view illustrating the electronic device of FIG. 1. As shown in FIGS. 1 and 2, the electronic device 1 comprises a glass cover plate 11, a fingerprint identification module 12 and plural function keys 13. For example, a sound volume control key is one of the function keys 13. The fingerprint identification module 12 is disposed within the electronic device 1 and installed on the glass cover plate 11. That is, the fingerprint identification module 12 is in an invisible fingerprint sensor (IFS) arrangement. While the function key 13 is depressed by the user, the electronic device 1 performs a corresponding control operation. For example, when the sound volume control key, the sound volume of the electronic device 1 is adjusted.

Moreover, the user's fingerprint may be inputted into the electronic device 1 and saved in the electronic device 1. For unlocking the electronic device 1, the user has to input the fingerprint through a fingerprint identification module 12 to complete an identification process. The way of unlocking the electronic device 1 by the fingerprint identification technology is faster and more user-friendly than the way of manually inputting the password. Consequently, the fingerprint identification technology is favored by many users, and the demands on the fingerprint identification module are gradually increased.

However, the conventional technology still has some drawbacks. Firstly, the only use of the fingerprint image to recognize the identity of the user is still inadequate for protecting the information security. For example, in case that the user has no behavioral capacity (e.g., the user in sleep), the person with a bad intention may easily exploit the finger of the user to unlock the electronic device 1. Secondly, the fingerprint identification module 12 occupies the layout space of the electronic device 1. Consequently, the fingerprint identification module 12 only provides a single function. Thirdly, the function keys 13 of the electronic device 1 are physical keys, which occupy the layout space of the electronic device 1. Moreover, the complexity of designing the waterproof structure is increased.

In other words, the fingerprint identification module and the electronic device need to be further improved.

### SUMMARY OF THE INVENTION

An object of the present invention provides a fingerprint identification module. The fingerprint identification module not only provides the fingerprint sensing function but also provides the position sensing function. Moreover, the fingerprint identification module can provide two-factor authentication, so that the efficacy of protecting the information safety is enhanced. When the fingerprint identification module is applied to a electronic device, the layout space of the physical keys can be reduced. For example, the physical keys includes a physical key for controlling the sound volume, a physical key for zooming in/out the image, the physical key for swiping a page. Under this circumstance, the volume of the electronic device is minimized, and the complexity of designing the waterproof structure is simplified.

In accordance with an aspect of the present invention, there is provided a fingerprint identification module. The fingerprint identification module includes a sensing surface, a circuit board, a control unit, a fingerprint sensor and a position sensor. The fingerprint sensor is arranged between the sensing surface and the circuit board. When a finger is placed on the sensing surface, a fingerprint image of the finger is sensed by the fingerprint sensor. The position sensor is arranged between the sensing surface and the circuit board, and electrically connected with the control unit. The position sensor senses at least one touch pressure on the sensing surface. The control unit acquires a position of the finger on the sensing surface according to the at least one touch pressure.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic front view illustrating an electronic device with a fingerprint identification module according to prior art;

FIG. 2 is a schematic side view illustrating the electronic device of FIG. 1;

FIG. 3 is a schematic cross-sectional view illustrating a fingerprint identification module according to an embodiment of the present invention;

FIG. 4 is a schematic front view illustrating an electronic device with the fingerprint identification module of FIG. 3;

FIG. 5 schematically illustrates the relationships between the pressure values sensed by the first pressure sensing part, the pressure values sensed by the second pressure sensing part and the positions of the user's finger on the sensing surface of the fingerprint identification module;

FIG. 6 schematically illustrates a method of controlling a volume sound of the electronic device in response to a sliding behavior of the user's finger on the sensing surface of the fingerprint identification module;

FIG. 7 schematically illustrates a method of controlling a zooming action of the electronic device in response to a sliding behavior of the user's finger on the sensing surface of the fingerprint identification module;

FIG. 8 schematically illustrates a method of controlling a page-swiping action of the electronic device in response to a sliding behavior of the user's finger on the sensing surface of the fingerprint identification module;

FIG. 9 schematically illustrates a method of inputting a password into the electronic device in response to a touching behavior of the user's finger on the sensing surface of the fingerprint identification module;

FIG. 10 is a flowchart illustrating a method of using the fingerprint identification module to recognize an identity according to an embodiment of the present invention; and

FIG. 11 is a flowchart illustrating a method of using the fingerprint identification module to recognize an identity according to another embodiment of the present invention.

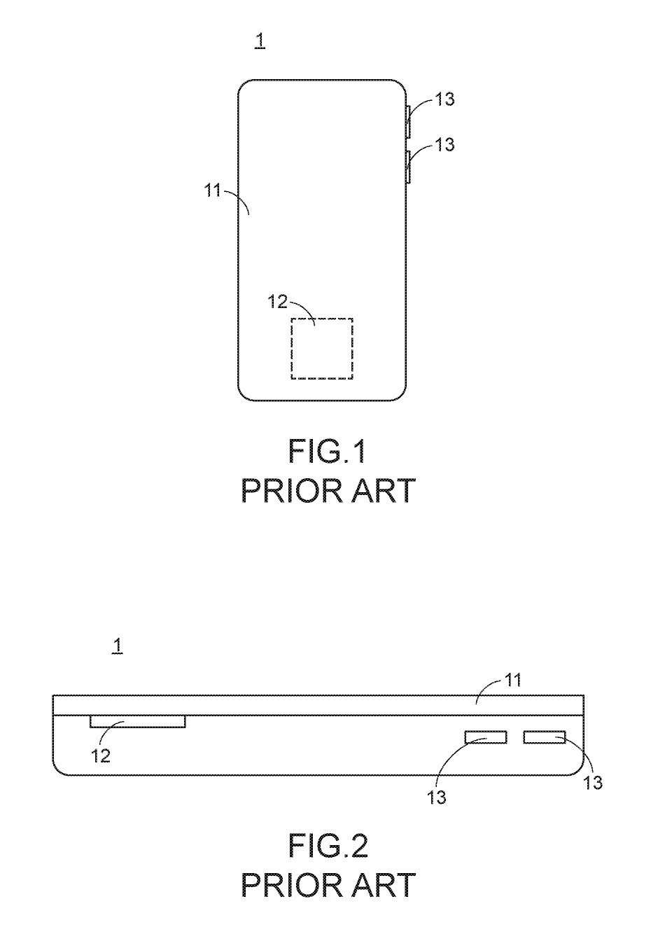

### DETAILED DESCRIPTION OF THE PREFERRED EMBODIMENT

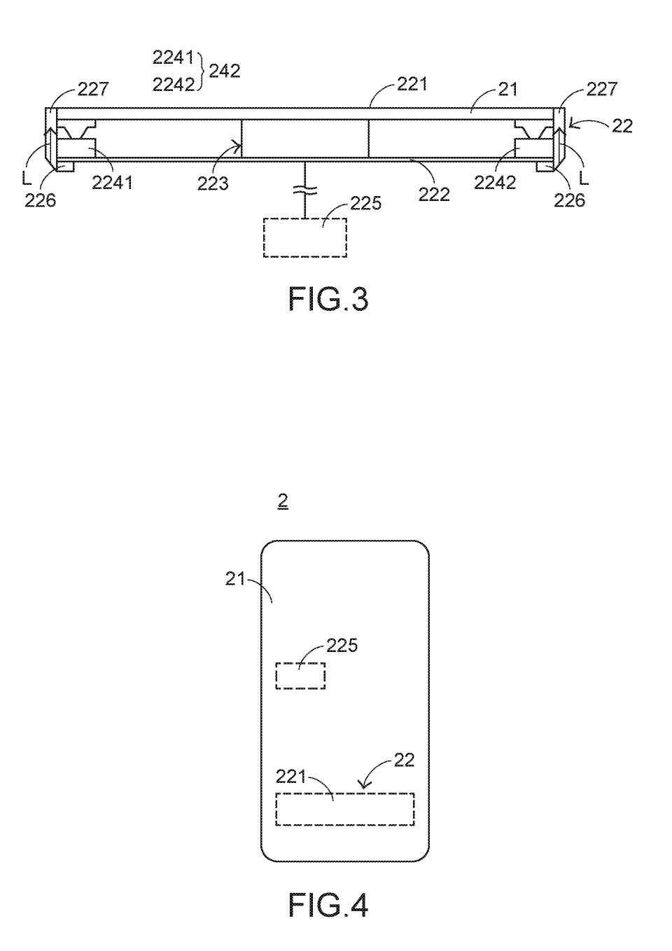

FIG. 3 is a schematic cross-sectional view illustrating a fingerprint identification module according to an embodiment of the present invention. FIG. 4 is a schematic front view illustrating an electronic device with the fingerprint identification module of FIG. 3. An example of the electronic device includes but is not limited to a handheld mobile device. As shown in FIGS. 3 and 4, the electronic device 2 comprises a glass cover plate 21 and a fingerprint identification module 22. The glass cover plate 21 is exposed to the outside. The fingerprint identification module 22 is disposed within the electronic device 2. In this embodiment, the fingerprint identification module 22 comprises a sensing surface 221, a circuit board 222, a fingerprint sensor 223, a position sensor 224 and a control unit 225. The sensing surface 221 is formed on the glass cover plate 21. The circuit board 222 is disposed within the electronic device 2. The fingerprint sensor 223 and the position sensor 224 are arranged between the sensing surface 221 and the circuit board 222.

When the user's finger is placed on the sensing surface 221, a fingerprint image of the finger is sensed by the fingerprint sensor 223. The position sensor 224 comprises a first pressure sensing part 2241 and a second pressure sensing part 2242. The first pressure sensing part 2241 and the second pressure sensing part 2242 are used for sensing a touch pressure of the user's finger on the sensing surface 221. In this embodiment, the fingerprint sensor 223 is arranged between the first pressure sensing part 2241 and the second pressure sensing part 2242. The circuit board 222 is a flexible printed circuit (FPC) or a rigid-flex board. All of the fingerprint sensor 223, the first pressure sensing part 2241 and the second pressure sensing part 2242 are installed on a circuit board 222 according to a surface mount technology (SMT). Moreover, the fingerprint sensor 223 has a land grid array (LGA) package structure or a ball grid array (BGA) structure. It is noted that numerous modifications and alterations may be made according to the practical requirements.

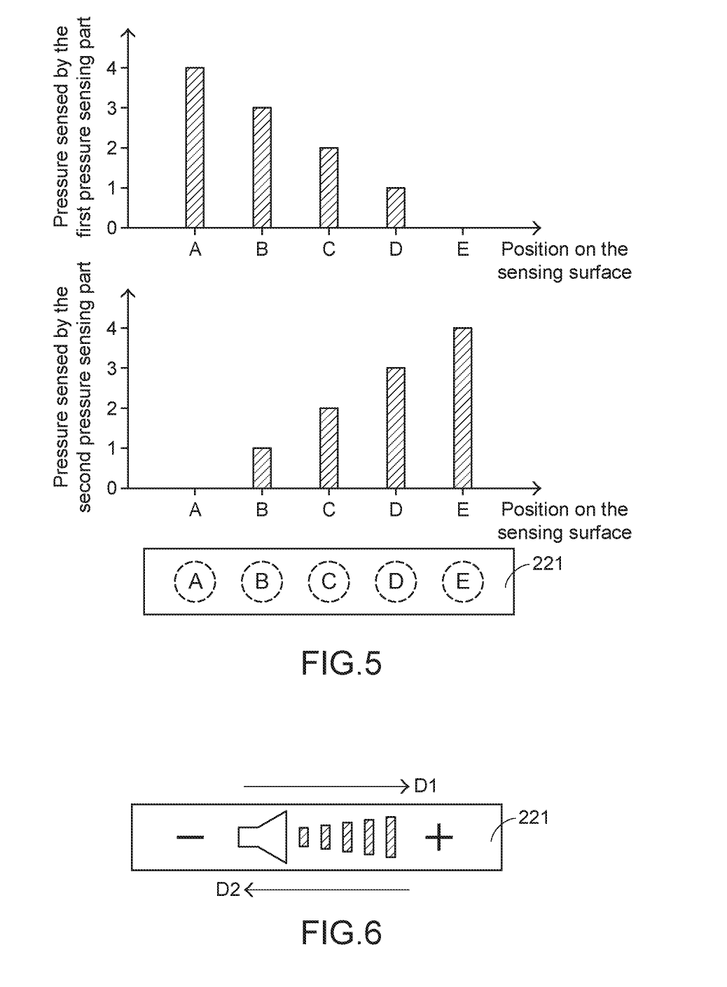

The control unit 225 is disposed within the electronic device 2. Moreover, the fingerprint sensor 223 and the position sensor 224 are electrically connected with the control unit 225 through the circuit board 222. The first pressure sensing part 2241 and the second pressure sensing part 2242 are located near two lateral sides of the sensing surface 221. According to the sensing result of the first pressure sensing part 2241 and the sensing result of the second pressure sensing part 2242, the control unit 225 acquires the position of the user's finger on the sensing surface 221. The principle of acquiring the position of the user's finger on the sensing surface 221 will be described with reference to FIG. 5.

FIG. 5 schematically illustrates the relationships between the pressure values sensed by the first pressure sensing part, the pressure values sensed by the second pressure sensing part and the positions of the user's finger on the sensing surface of the fingerprint identification module. Please refer to FIG. 5. If the pressure values sensed by the first pressure sensing part 2241 and the second pressure sensing part 2242 are respectively 4 units and 0 unit, the control unit 225 detects that the user's finger is placed on a position A of the sensing surface 221. If the pressure values sensed by the first pressure sensing part 2241 and the second pressure sensing part 2242 are respectively 3 units and 1 unit, the control unit 225 detects that the user's finger is placed on a position B of the sensing surface 221. If the pressure values sensed by the first pressure sensing part 2241 and the second pressure sensing part 2242 are both 2 units, the control unit 225 detects that the user's finger is placed on a position C of the sensing surface 221. If the pressure values sensed by the first pressure sensing part 2241 and the second pressure sensing part 2242 are respectively 1 unit and 3 units, the control unit 225 detects that the user's finger is placed on a position D of the sensing surface 221. If the pressure values sensed by the first pressure sensing part 2241 and the second pressure sensing part 2242 are respectively 0 unit and 4 units, the control unit 225 detects that the user's finger is placed on a position E of the sensing surface 221. The above example is presented herein for purpose of illustration and description only. That is, the way of acquiring the position of the user's finger on the sensing surface 221 is not restricted to the way of according to the sensing result of the first pressure sensing part 2241 and the sensing result of the second pressure sensing part 2242.

Moreover, the control unit 225 of the fingerprint identification module 22 recognizes the operation behavior of the user's finger according to a sequence of touching plural positions of the sensing surface 221 by the user's finger within a predetermined time period. According to the operation behavior of the user's finger, the control unit 225 performs a corresponding function of the electronic device 2. Hereinafter, some implementation examples will be described with reference to FIGS. 6, 7, 8 and 9.

Please refer to FIGS. 5 and 6. FIG. 6 schematically illustrates a method of controlling a volume sound of the electronic device in response to a sliding behavior of the user's finger on the sensing surface of the fingerprint identification module. In a situation, the user's finger is moved on the sensing surface 221 in the direction D1 within the predetermined time period. For example, if the control unit 225 judges that the position A, the position B and the position C of the sensing surface 221 are sequentially touched by the user's finger within the predetermined time period, the control unit 225 judges that the operation behavior of the user's finger is a rightward sliding behavior. In another situation, the user's finger is moved on the sensing surface 221 in the direction D2 within the predetermined time period. For example, if the control unit 225 judges that the position D, the position C and the position B of the sensing surface 221 are sequentially touched by the user's finger within the predetermined time period, the control unit 225 judges that the operation behavior of the user's finger is a leftward sliding behavior. In the example of FIG. 6, the control unit 225 judges that the operation behavior of the user's finger on the sensing surface 221 is the rightward sliding behavior. Consequently, the sound volume of the electronic device 2 is increased under control of the control unit 225. Whereas, if the control unit 225 judges that the operation behavior of the user's finger on the sensing surface 221 is the leftward sliding behavior, the sound volume of the electronic device 2 is decreased under control of the control unit 225.

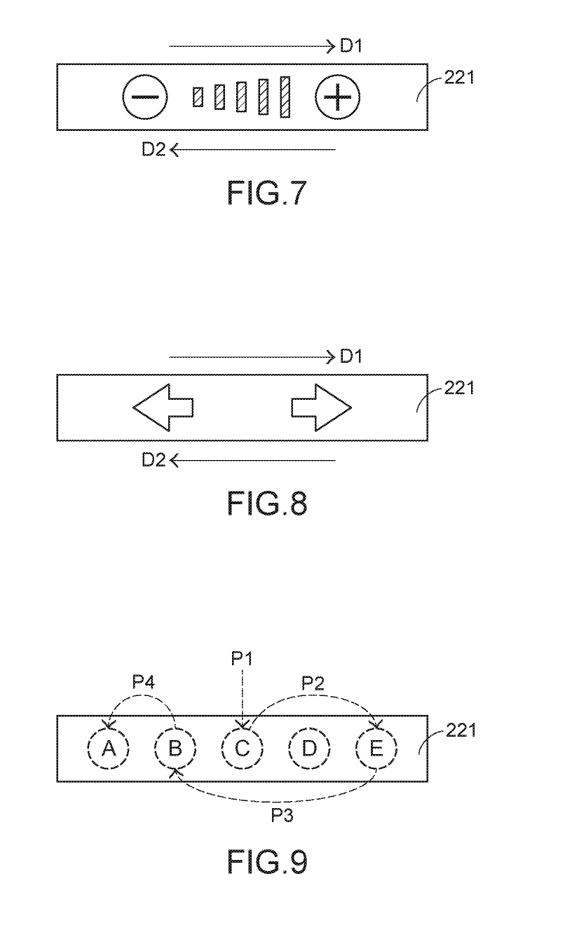

Please refer to FIGS. 5 and 7. FIG. 7 schematically illustrates a method of controlling a zooming action of the electronic device in response to a sliding behavior of the user's finger on the sensing surface of the fingerprint identification module. In a situation, the user's finger is moved on the sensing surface 221 in the direction D1 within the predetermined time period. For example, if the control unit 225 judges that the position C, the position D and the position E of the sensing surface 221 are sequentially touched by the user's finger within the predetermined time period, the control unit 225 judges that the operation behavior of the user's finger is a rightward sliding behavior. In another situation, the user's finger is moved on the sensing surface 221 in the direction D2 within the predetermined time period. For example, if the control unit 225 judges that the position E, the position D, the position C and the position B of the sensing surface 221 are sequentially touched by the user's finger within the predetermined time period, the control unit 225 judges that the operation behavior of the user's finger is a leftward sliding behavior. In the example of FIG. 7, the control unit 225 judges that the operation behavior of the user's finger on the sensing surface 221 is the rightward sliding behavior. Consequently, the zoom-in action of the electronic device 2 is performed under control of the control unit 225. For example, an image shown on the electronic device 2 is scaled up. Whereas, if the control unit 225 judges that the operation behavior of the user's finger on the sensing surface 221 is the leftward sliding behavior, the zoom-out action of the electronic device 2 is performed under control of the control unit 225. For example, the image shown on the electronic device 2 is scaled down.

Please refer to FIGS. 5 and 8. FIG. 8 schematically illustrates a method of controlling a page-swiping action of the electronic device in response to a sliding behavior of the user's finger on the sensing surface of the fingerprint identification module. In a situation, the user's finger is moved on the sensing surface 221 in the direction D1 within the predetermined time period. For example, if the control unit 225 judges that the position B, the position C and the position D of the sensing surface 221 are sequentially touched by the user's finger within the predetermined time period, the control unit 225 judges that the operation behavior of the user's finger is a rightward sliding behavior. In another situation, the user's finger is moved on the sensing surface 221 in the direction D2 within the predetermined time period. For example, if the control unit 225 judges that the position C, the position B and the position A of the sensing surface 221 are sequentially touched by the user's finger within the predetermined time period, the control unit 225 judges that the operation behavior of the user's finger is a leftward sliding behavior. In the example of FIG. 8, the control unit 225 judges that the operation behavior of the user's finger on the sensing surface 221 is the rightward sliding behavior. Consequently, the page-swiping action of the electronic device 2 is performed under control of the control unit 225. For example, a web page shown on the electronic device 2 is swiped to a next page. Whereas, if the control unit 225 judges that the operation behavior of the user's finger on the sensing surface 221 is the leftward sliding behavior, the page-swiping action of the electronic device 2 is performed under control of the control unit 225. For example, the web page shown on the electronic device 2 is swiped to a previous page.

FIG. 9 schematically illustrates a method of inputting a password into the electronic device in response to a touching behavior of the user's finger on the sensing surface of the fingerprint identification module. For example, the electronic device 2 has a password “CEBA”. The password is a default password, or the password is previously stored into the electronic device 2 by the user. Moreover, the user may input the password into the electronic device 2 through the fingerprint identification module 22. For example, if the position C (Step P1), the position E (Step P2), the position B (Step P3) and the position A (Step P4) of the sensing surface 221 are sequentially touched by the user's finger within the predetermined time period, the control unit 225 judges that the operation behavior of the user's finger is a password-inputting behavior. If the sequence of touching these positions complies with the predetermined sequence, the control unit 225 judges that the password is successfully inputted. Meanwhile, the control unit 225 enables a specified function of the electronic device 2. For example, the operation system is accessed or the fingerprint identification function is enabled. Whereas, if the sequence of touching these positions does not comply with the predetermined sequence, the control unit 225 judges that the password is not successfully inputted.

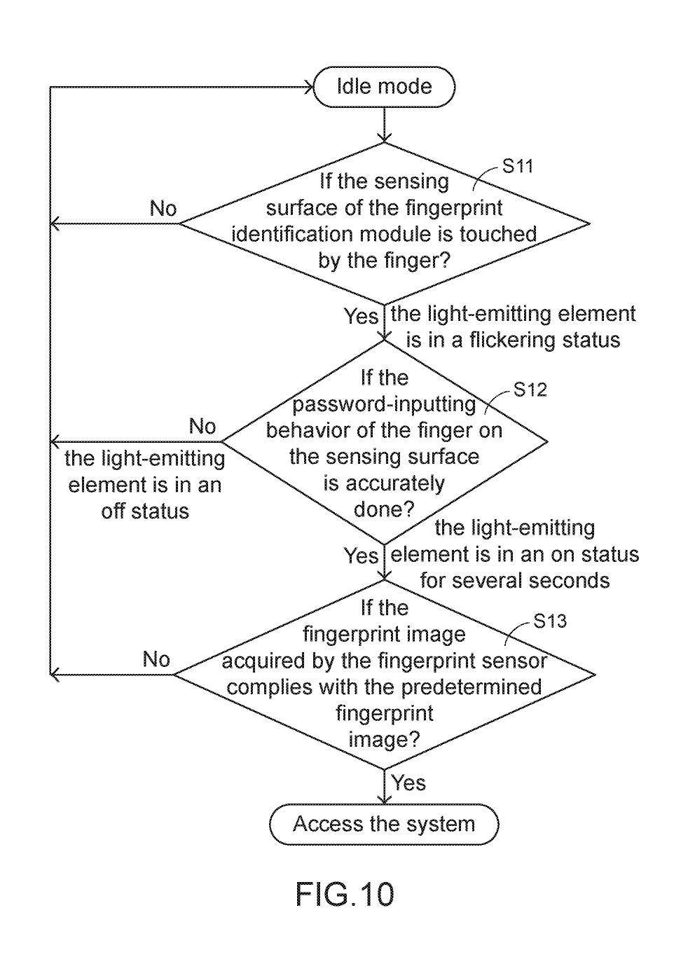

Please refer to FIGS. 3 and 4. In this embodiment, the fingerprint identification module 22 further comprises at least one light-emitting element 226. The at least one light-emitting element 226 is electrically connected with the control unit 225 and located near the circuit board 222. The at least one light-emitting element 226 emits a light beam L to indicate the position of the sensing surface 221 of the fingerprint identification module 22 or the usage status of the fingerprint identification module 22. An example of using the light-emitting element 226 to indicate the usage status of the fingerprint identification module 22 will be described with reference to FIG. 10. Preferably but not exclusively, the fingerprint identification module 22 further comprises a light guide structure 227. The light guide structure 227 is arranged around the sensing surface 221 and located near the light-emitting element 226. The light beam L is guided by the light guide structure 227. Consequently, the light beam L is outputted from a periphery region of the sensing surface 221.

FIG. 10 is a flowchart illustrating a method of using the fingerprint identification module to recognize an identity according to an embodiment of the present invention. Firstly, the electronic device 2 is in an idle mode. Then, the control unit 225 performs a step S11 to judge whether the sensing surface 221 of the fingerprint identification module 22 is touched by the user's finger. If the control unit 225 judges that the sensing surface 221 of the fingerprint identification module 22 is not touched by any finger, the control unit 225 judges that the electronic device 2 is still in the idle mode. If the control unit 225 judges that the sensing surface 221 of the fingerprint identification module 22 is touched by a finger, the light-emitting element 226 is in a flickering status to indicate that the password-inputting behavior of the user's finger on the sensing surface 221 can be started. Then, the control unit 225 performs a step S12 to judge whether the password-inputting behavior of the user's finger on the sensing surface 221 is accurately done through the position sensor 224.

If the control unit 225 judges that the password-inputting behavior of the user's finger is not accurately done, the light-emitting element 226 is in an off state to prompt the user that the password is not successfully inputted. Meanwhile, the electronic device 2 is returned to the idle mode. Whereas, if the control unit 225 judges that the password-inputting behavior of the user's finger is accurately done, the light-emitting element 226 is in an on status for several seconds to prompt the user that the password is successfully inputted. Meanwhile, the control unit 225 controls the fingerprint sensor 223 to sense the fingerprint image of the user's finger. Then, the control unit 225 performs a step S13 to judge whether the fingerprint image acquired by the fingerprint sensor 223 complies with the predetermined fingerprint image.

If the control unit 225 judges that the fingerprint image acquired by the fingerprint sensor 223 does not comply with the predetermined fingerprint image, the electronic device 2 is returned to the idle mode. Whereas, if the control unit 225 judges that the fingerprint image acquired by the fingerprint sensor 223 complies with the predetermined fingerprint image, the operation system of the electronic device 2 is accessed.

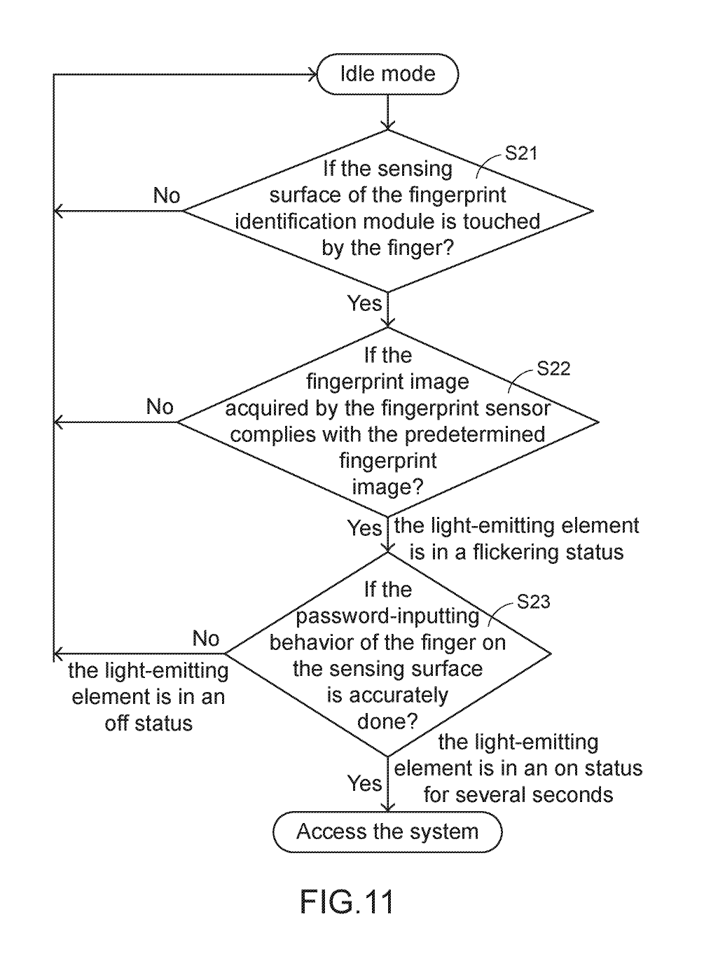

FIG. 11 is a flowchart illustrating a method of using the fingerprint identification module to recognize an identity according to another embodiment of the present invention. Firstly, the electronic device 2 is in an idle mode. Then, the control unit 225 performs a step S21 to judge whether the sensing surface 221 of the fingerprint identification module 22 is touched by the user's finger. If the control unit 225 judges that the sensing surface 221 of the fingerprint identification module 22 is not touched by any finger, the control unit 225 judges that the electronic device 2 is still in the idle mode. If the control unit 225 judges that the sensing surface 221 of the fingerprint identification module 22 is touched by a finger, the light-emitting element 226 is in a flickering status to indicate that the password-inputting behavior of the user's finger on the sensing surface 221 can be started. Then, the control unit 225 performs a step S22 to judge whether the fingerprint image acquired by the fingerprint sensor 223 complies with the predetermined fingerprint image.

If the control unit 225 judges that the fingerprint image acquired by the fingerprint sensor 223 does not comply with the predetermined fingerprint image, the electronic device 2 is returned to the idle mode. Whereas, if the control unit 225 judges that the fingerprint image acquired by the fingerprint sensor 223 complies with the predetermined fingerprint image, the light-emitting element 226 is in a flickering status to indicate that the password-inputting behavior of the user's finger on the sensing surface 221 can be started. Then, the control unit 225 performs a step S23 to judge whether the password-inputting behavior of the user's finger on the sensing surface 221 is accurately done through the position sensor 224.

If the control unit 225 judges that the password-inputting behavior of the user's finger is not accurately done, the light-emitting element 226 is in an off state to prompt the user that the password is not successfully inputted. Meanwhile, the electronic device 2 is returned to the idle mode. Whereas, if the control unit 225 judges that the password-inputting behavior of the user's finger is accurately done, the light-emitting element 226 is in an on status for several seconds to prompt the user that the password is successfully inputted. Meanwhile, the operation system of the electronic device 2 is accessed.

From the above descriptions, the fingerprint identification module 22 not only provides the fingerprint sensing function but also provides the position sensing function. Consequently, when the fingerprint identification module 22 is applied to the electronic device 2, the layout space of the physical keys can be reduced. For example, the physical keys includes a physical key for controlling the sound volume, a physical key for zooming in/out the image, the physical key for swiping a page. Under this circumstance, the volume of the electronic device 2 is minimized, and the complexity of designing the waterproof structure is simplified. Moreover, the fingerprint identification module 22 of the present invention can provide two-factor authentication, e.g., the fingerprint authentication and the password authentication. Consequently, the efficacy of protecting the information safety is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A fingerprint identification module, comprising:
a sensing surface;
a circuit board;
a control unit;
a fingerprint sensor arranged between the sensing surface and the circuit board, wherein when a finger is placed on the sensing surface, a fingerprint image of the finger is sensed by the fingerprint sensor; and
a position sensor arranged between the sensing surface and the circuit board, and electrically connected with the control unit, wherein the position sensor senses at least one touch pressure on the sensing surface, and the control unit acquires a position of the finger on the sensing surface according to the at least one touch pressure.

2. The fingerprint identification module according to claim 1, wherein the position sensor comprises a first pressure sensing part and a second pressure sensing part, and the first pressure sensing part and the second pressure sensing part are respectively located near two lateral sides of the sensing surface, wherein the control unit acquires the position of the finger on the sensing surface according to a sensing result of the first pressure sensing part and a sensing result of the second pressure sensing part.

3. The fingerprint identification module according to claim 2, wherein the fingerprint sensor is arranged between the first pressure sensing part and the second pressure sensing part.

4. The fingerprint identification module according to claim 1, wherein the control unit recognizes an operation behavior of the finger according to a sequence of touching plural positions of the sensing surface by the finger within a predetermined time period.

5. The fingerprint identification module according to claim 4, wherein the operation behavior is a password-inputting behavior, wherein if the plural positions of the sensing surface touched by the finger are predetermined positions and the sequence of touching plural positions of the sensing surface within the predetermined time period complies with a predetermined sequence, the control unit judges that the password-inputting behavior is correctly done.

6. The fingerprint identification module according to claim 5, wherein the fingerprint sensor senses the fingerprint image after the control unit judges that the password-inputting behavior is correctly done, or the control unit recognizes the password-inputting behavior according to the at least one touch pressure sensed by the position sensor after the fingerprint image is sensed by the fingerprint sensor.

7. The fingerprint identification module according to claim 4, wherein the operation behavior is a sliding behavior.

8. The fingerprint identification module according to claim 7, wherein a sound volume is adjusted, a zoom control action is performed or a page is swiped in response to the sliding behavior.

9. The fingerprint identification module according to claim 1, wherein the fingerprint identification module further includes a light-emitting element, and the light-emitting element is electrically connected with the control unit, wherein the light-emitting element emits a light beam to indicate a usage status of the fingerprint identification module.

10. The fingerprint identification module according to claim 1, wherein the fingerprint sensor is installed on the circuit board according to a surface mount technology, or the position sensor is installed on the circuit board according to a surface mount technology, or the circuit board is a flexible printed circuit.
